(19) United States
(12) Patent Application Publication
(10) Pub. No.: US 2024/0094355 A1
(43) Pub. Date: Mar. 21, 2024

(54) TEMPERATURE DEPENDENT LIDAR SENSOR

(71) Applicant: Continental Autonomous Mobility US, LLC, Auburn Hills, MI (US)

(72) Inventors: Jacob A Bergam, Goleta, CA (US); William F Borba, Santa Barbara, CA (US)

(73) Assignee: Continental Autonomous Mobility US, LLC, Auburn Hills, MI (US)

(21) Appl. No.: 17/933,862

(22) Filed: Sep. 21, 2022

(51) Int. Cl. G01S 7/484; G01K 7/02; G01S 17/10; G01S 17/89; G01S 17/931

(52) U.S. Cl. CPC G01S 7/484; G01K 7/02; G01S 17/10; G01S 17/89; G01S 17/931

(57) ABSTRACT

A LiDAR sensor includes a light emitter designed to emit light into a field of illumination. The wavelength of the light emitted by the light emitter is dependent on the temperature of the light emitter. A light detector has a field of view overlapping the field of illumination. A bandpass filter is between the light detector and the field of illumination of the light emitter. The bandpass filter is designed to pass light to the light detector in a wavelength range that is dependent on the temperature of the bandpass filter. The LiDAR sensor includes at least one temperature controller. The light emitter is coupled to a temperature controller and the bandpass filter is coupled to a temperature controller. A method of operating the LiDAR sensor includes controlling the temperatures of the bandpass filter and the light emitter.

### BACKGROUND

A LiDAR (Light Detection And Ranging) sensor includes a photodetector and a light emitter. The light emitter emits light into a field of view of the photodetector and the photodetector detects light that is reflected by an object in the field of view, conceptually modeled as a packet of photons.ba

As one example, the system may be a mechanical LiDAR system, also referred to as a rotating LiDAR system. As a mechanical LiDAR system, a light-emission system of the LiDAR system includes one or more light emitters and one or more spinning mirrors and aim light from the light emitter through the exit window. In such an example, the field of illumination FOI surrounds the vehicle, i.e., is in 360 degrees. In such an example, the light-receiving system of the LiDAR system may include a plurality of image sensors each including arrays of the photodetectors.

As another example, a non-scanning LiDAR (Light Detection And Ranging) sensor, e.g., a solid-state LADAR sensor, includes a photodetector, or an array of photodetectors, that is fixed in place relative to a carrier, e.g., a vehicle. Light is emitted into the field of view of the photodetector and the photodetector detects light that is reflected by an object in the field of view, conceptually modeled as a packet of photons. For example, a Flash LADAR sensor emits pulses of light, e.g., laser light, into the entire field of view. The detection of reflected light is used to generate a three-dimensional (3D) environmental map of the surrounding environment. The time of flight of reflected photons detected by the photodetector is used to determine the distance of the object that reflected the light.

The LiDAR sensor may be mounted on a vehicle to detect objects in the environment surrounding the vehicle and to detect distances of those objects for environmental mapping. The output of the LiDAR sensor may be used, for example, to autonomously or semi-autonomously control operation of the vehicle, e.g., propulsion, braking, steering, etc. Specifically, the LiDAR sensor may be a component of or in communication with an advanced driver-assistance system (ADAS) of the vehicle.

### BRIEF DESCRIPTION OF THE DRAWINGS

FIG. 1 is a perspective view of a vehicle including a LiDAR sensor.

FIG. 2 is a perspective view of the LiDAR sensor.

FIG. 3 is a schematic cross-section of one example of the LiDAR sensor.

FIG. 4 is a schematic cross-section of another example of the LiDAR sensor.

FIG. 5 is a perspective view of a light detector of the LiDAR assembly.

FIG. 5A is a magnified view of the light detector schematically showing an array of photodetectors.

FIG. 6 is a block diagram of the LiDAR sensor.

FIG. 7 is a graph showing variation in wavelength range passed by a bandpass filter of the LiDAR sensor as dependent on the temperature of the bandpass filter. The data in FIG. 7 is example data and is not presented as test data.

FIG. 8 is a block diagram of a method of operating the LiDAR sensor.

### DETAILED DESCRIPTION

With reference to the figures, wherein like numerals indicate like parts throughout the several views, a LiDAR sensor 10 includes a light emitter 14 designed to emit light into a field of illumination FOI. The wavelength of the light emitted by the light emitter 14 is dependent on the temperature of the light emitter 14. The light detector 16 has a field of view FOV overlapping the field of illumination FOI. A bandpass filter 18 is between the light detector 16 and the field of illumination FOI of the light emitter 14. The bandpass filter 18 is designed to pass light to the light detector 16 in a wavelength range that is dependent on the temperature of the bandpass filter 18. The LiDAR sensor 10 includes at least one temperature controller 34, 36, 50. The light emitter 14 is coupled to at least one of the at least one temperature controller 34, 36, 50 and the bandpass filter 18 is coupled to at least one of the at least one temperature controller 34, 36, 50.

Since the temperature of the light emitter 14 and the temperature of the bandpass filter 18 is controlled by at least one temperature controller 34, 36, 50, the light emitter 14 and the bandpass filter 18 may be operated at temperatures so that the wavelength of the light emitted from the light emitter 14 is in the wavelength range of light passed by the bandpass filter 18. Accordingly, the bandpass filter 18 may be designed to minimize the wavelength range and the temperature control of the light emitter 14 and the bandpass filter 18 ensures that the light emitted from the light emitter 14 is passed by the bandpass filter 18 to the light detector 16. The reduction in the wavelength range reduces the likelihood that the bandpass filter 18 passes light that is not emitted by the light emitter 14 (hereinafter referred to as “unwanted light”), e.g., solar emissions, light from light emitters other than the light emitter 14 of the LiDAR sensor 10, etc. This reduces the potential detection of unwanted light by the light detector 16. As an example, this reduction of potential detection of unwanted light may be useful in digital systems, e.g., SPADs as described further below. The reduction of potential detection of unwanted light may be used to increase the dynamic range of the LiDAR sensor 10 to allow for detection of very reflective objects near the LiDAR sensor 10 and dim objects far from the LiDAR sensor 10.

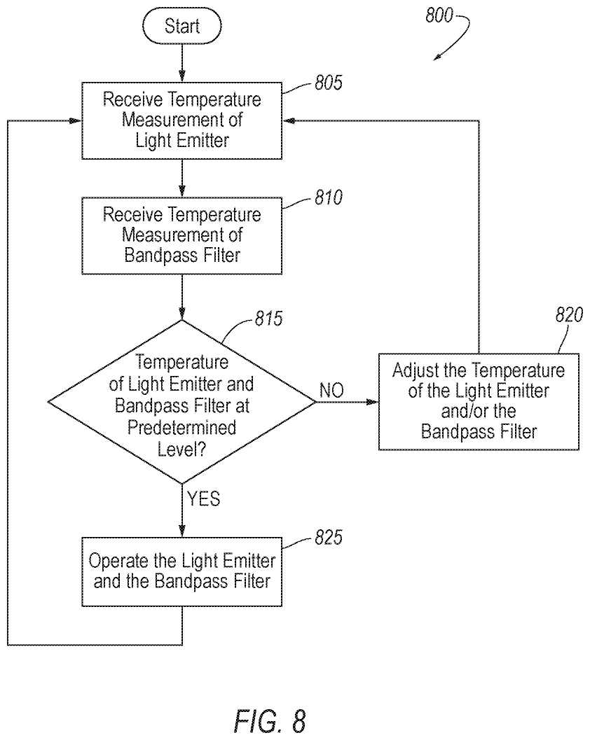

With reference to FIG. 8, a method 800 of operating the LiDAR sensor 10 includes emitting light from the light emitter 14 into the field of illumination FOI. The method includes, with the light detector 16, detecting light from the field of illumination FOI through the bandpass filter 18. The method 800 includes controlling the temperature of the bandpass filter 18 to pass light in a wavelength range and controlling the temperature of the light emitter 14 to emit light having a wavelength in the wavelength range of the bandpass filter 18. By controlling the temperature of the light emitter 14 to emit light in the wavelength range passed by the bandpass filter 18 to pass light in the wavelength range of the bandpass filter 18, the method 800 may be used to reduce the potential detection of unwanted light as described above.

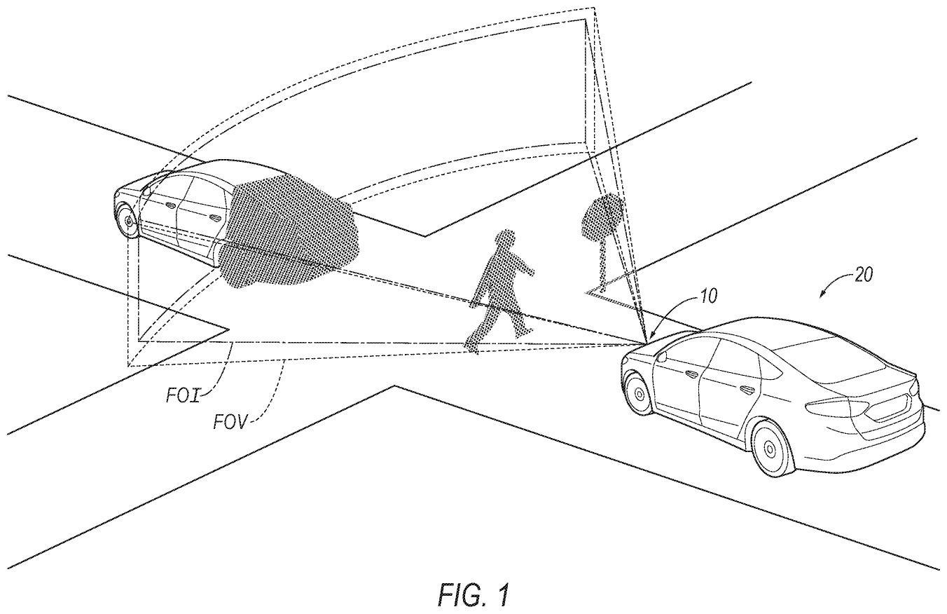

The LiDAR sensor 10 is shown in FIG. 1 as being mounted on a vehicle 20. In such an example, the LiDAR sensor 10 is operated to detect objects in the environment surrounding the vehicle 20 and to detect distance, i.e., range, of those objects for environmental mapping. The output of the LiDAR sensor 10 may be used, for example, to autonomously or semi-autonomously control operation of the vehicle, e.g., propulsion, braking, steering, etc. Specifically, the LiDAR sensor 10 may be a component of or in communication with an advanced driver-assistance system (ADAS) 22 of the vehicle. The LiDAR sensor 10 may be mounted on the vehicle 20 in any suitable position and aimed in any suitable direction. As one example, the LiDAR sensor 10 is shown on the front of the vehicle 20 and directed forward. The vehicle may have more than one LiDAR sensor 10 and/or the vehicle 20 may include other object detection systems, including other LiDAR systems. The vehicle 20 shown in the figures is a passenger automobile. As other examples, the vehicle 20 may be of any suitable manned or un-manned type including a plane, satellite, drone, watercraft, etc.

As one example, the LiDAR sensor 10 may be a non-scanning sensor as shown in the figures. For example, the LiDAR sensor 10 may be a solid-state LiDAR. In such an example, the LiDAR sensor 10 is stationary relative to the vehicle in contrast to a mechanical LiDAR, also called a rotating LiDAR, that rotates 360 degrees. The solid-state LiDAR sensor, for example, may include a casing 24 that is fixed relative to the vehicle 22, i.e., does not move relative to the component of the vehicle 22 to which the casing 24 is attached, and components of the LiDAR sensor 10 are supported in the casing 24. As a solid-state LiDAR, the LiDAR sensor 10 may be a flash LiDAR sensor. In such an example, the LiDAR sensor 10 emits pulses, i.e., flashes, of light into a field of illumination FOI. More specifically, the LiDAR sensor 10 may be a 3D flash LiDAR sensor that generates a 3D environmental map of the surrounding environment. In a flash LiDAR sensor 10, the FOI illuminates a field of view FOV of the light detector 16. Another example of solid-state LiDAR includes an optical-phase array (OPA). Another example of solid-state LiDAR is a micro-electromechanical system (MEMS) scanning LiDAR, which may also be referred to as a quasi-solid-state LiDAR. As another example, the LiDAR sensor 10 may be a mechanical LiDAR system, also referred to as a rotating LiDAR system. As a mechanical LiDAR system, the LiDAR system 10 includes one or more light emitters and one or more spinning mirrors and aim light from the light emitter through an exit window. In such an example, the field of illumination FOI surrounds the vehicle 20, i.e., is in 360 degrees.

The LiDAR sensor 10 emits infrared light and detects (i.e., with photodetectors 64) the emitted light that is reflected by an object in the field of view FOV, e.g., pedestrians, street signs, vehicles, etc. Specifically, the LiDAR sensor 10 includes a light-emission system 26, a light-receiving system 28, and a controller 30 that controls the light-emission system 26 and the light-receiving system 28.

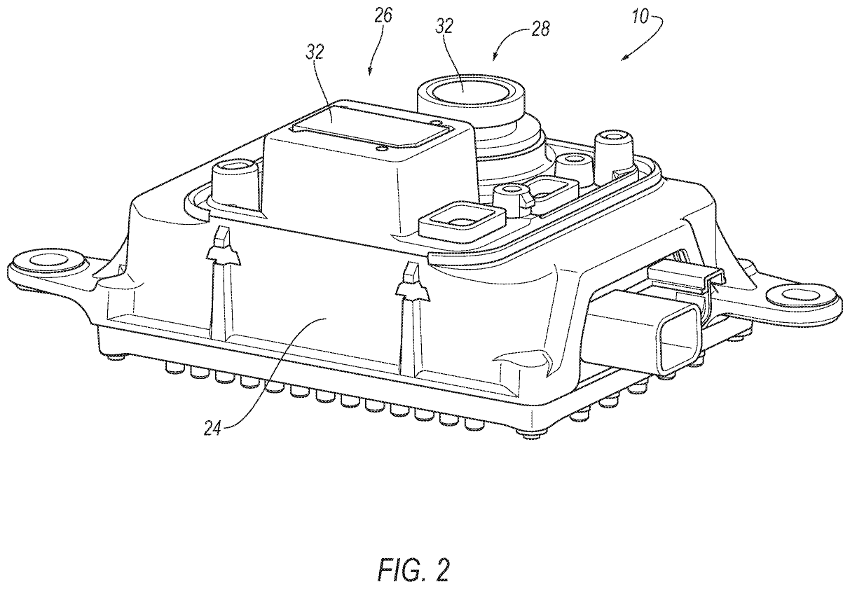

With reference to FIGS. 2-4, the LiDAR sensor 10 may be a unit. Specifically, the casing 24 supports the light-emission system 26 and the light-receiving system 28. The casing 24 may enclose the light-emission system 26 and the light-receiving system 28. The casing 24 may include mechanical attachment features to attach the casing 24 to the vehicle and electronic connections to connect to and communicate with electronic system of the vehicle 20, e.g., components of the ADAS 22. At least one window 32 extends through the casing 24. Specifically, the casing 24 includes an aperture and the window 32 extends across the aperture to pass light from the LiDAR sensor 10 into the field of illumination FOI and to receive light into the LiDAR sensor 10 from the field of view FOV. The casing 24, for example, may be plastic or metal and may protect the other components of the LiDAR sensor 10 from moisture, environmental precipitation, dust, etc. In the alternative to the LiDAR sensor 10 being a unit, components of the LiDAR sensor 10, e.g., the light-emission system 26 and the light-receiving system 28, may be separated and disposed at different locations of the vehicle.

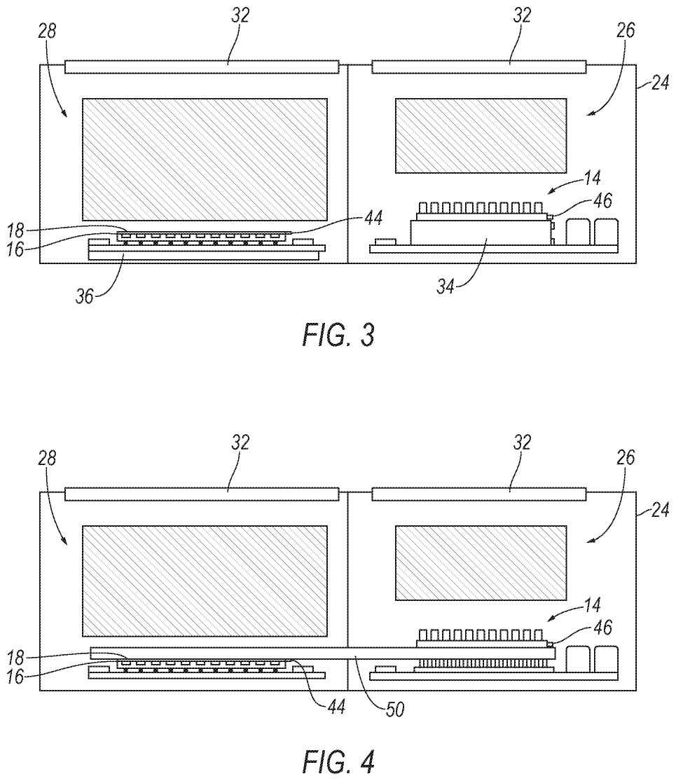

With reference to FIGS. 3-4, the light-emission system 26 may include one or more light emitter 14 and optical components such as a lens package, lens crystal, pump delivery optics, etc. The optical components are between the light emitter 14 and the window 32. Thus, light emitted from the light emitter 14 passes through the optical components before exiting the casing 24 through the window 32. The optical components include at least one optical element (not numbered) and may include, for example, a diffuser, a collimating lens, transmission optics, etc. The optical components direct, focus, and/or shape the light into the field of illumination FOI. The optical element may be of any suitable type that shapes and directs light from the light emitter 14 toward the window 32. For example, the optical element may be or include a diffractive optical element, a diffractive diffuser, a refractive diffuser, etc. The optical element may be transmissive and, in such an example, may be transparent. As another example, the optical element may be reflective, a hologram, etc.

The light emitter 14 is designed to emit light into the field of illumination FOI. The light emitter 14 is aimed at the optical element, i.e., substantially all of the light emitted from the light emitter 14 reaches the optical element. The optical element directs the shapes light for illuminating the field of illumination FOI exterior to the LiDAR sensor 10. In other words, the optical element is designed to direct the shaped light to the window 32, i.e., is sized, shaped, positioned, and/or has optical characteristics to direct the shape light. As an example, the optical element may be designed to shape the light from the light emitter 14 to be in an elongated pattern into the field of illumination FOI. As one example of shaping the light, the optical element diffuses the light, i.e., spreads the light over a larger path and reduces the concentrated intensity of the light. Light from the light emitter 14 may travel directly from the light emitter 14 to the optical element or may interact with additional components between the light emitter 14 and the optical element. The shaped light from the optical element may travel directly to the window 32 or may interact with additional components between the optical element the window 32 before exiting the window 32 into the field of illumination FOI.

The light emitter 14 emits light for illuminating objects for detection. The light-emission system 26 may include a beam-steering device (not shown) between the light emitter 14 and the window. The controller 30 is in communication with the light emitter 14 for controlling the emission of light from the light emitter 14 and, in examples including a beam-steering device, the controller 30 is in communication with the beam-steering device for aiming the emission of light from the LiDAR sensor 10 into the field of illumination FOI.

The light emitter 14 emits light into the field of illumination FOI for detection by the light-receiving system 28 when the light is reflected by an object in the field of view FOV. In the example in which the LiDAR sensor 10 is flash LiDAR, the light emitter 14 emits shots, i.e., pulses, of light into the field of illumination FOI for detection by the light-receiving system 28 when the light is reflected by an object in the field of view FOV to return photons to the light-receiving system 28. Specifically, the light emitter 14 emits a series of shots. As an example, the series of shots may be 1,500-2,500 shots. The light-receiving system 28 has a field of view FOV that overlaps the field of illumination FOI and receives light reflected by surfaces of objects, buildings, road, etc., in the FOV. In other words, the light-receiving system 28 detects shots emitted from the light emitter 14 and reflected in the field of view FOV back to the light-receiving system 28, i.e., detected shots. The light emitter 14 may be in electrical communication with the controller 30, e.g., to provide the shots in response to commands from the controller 30.

The light emitter 14 may be, for example, a laser. The light emitter 14 may be, for example, a semiconductor light emitter 14, e.g., laser diodes. In one example, the light emitter 14 is a vertical-cavity surface-emitting laser (VCSEL). As another example, the light emitter 14 may be a diode-pumped solid-state laser (DPSSL). As another example, the light emitter 14 may be an edge emitting laser diode. The light emitter 14 may be designed to emit a pulsed flash of light, e.g., a pulsed laser light. Specifically, the light emitter 14, e.g., the VCSEL or DPSSL or edge emitter, is designed to emit a pulsed laser light or train of laser light pulses. The light emitted by the light emitter 14 may be, for example, infrared light having a wavelength based on the temperature of the light emitter 14, as described below. In the alternative to infrared light, the light emitted by the light emitter 14 may be of any suitable wavelength. The LiDAR sensor 10 may include any suitable number of light emitters 14, i.e., one or more in the casing 24. In examples that include more than one light emitter 14, the light emitters 14 may be arranged in a column or in columns and rows. In examples that include more than one light emitter 14, the light emitters 14 may be identical or different and may each be controlled by the controller 30 for operation individually and/or in unison.

The light emitter 14 may be stationary relative to the casing 24. In other words, the light emitter 14 does not move relative to the casing 24 during operation of the LiDAR sensor 10, e.g., during light emission. The light emitter 14 may be mounted to the casing 24 in any suitable fashion such that the light emitter 14 and the casing 24 move together as a unit.

The performance of the light emitter 14 is dependent on the temperature of the light emitter 14 during operation. Specifically, the wavelength of the light emitted by the light emitter 14 is dependent on the temperature of the light emitter 14. As an example, one example light emitter 14 may have an operating temperature of 60-80 C and may emit light at between 937-943 nm. In such an example, the light emitter 14 may emit light at 940 nm at an operating temperature of 70 C. As set forth further below, the light emitter 14 is coupled to a temperature controller to regulate the temperature of the light emitter 14.

The light-receiving system 28 has a field of view FOV that overlaps the field of illumination FOI and receives light reflected by objects in the FOV. Stated differently, the field of illumination FOI generated by the light-emitting system overlaps the field of view of the light-receiving system 28. The light-receiving system 28 may include receiving optics and a light detector 16 having the array of photodetectors 64. The light-receiving system 28 may include a window 32 and the receiving optics (not numbered) may be between the window 32 and the light detector 16. The receiving optics may be of any suitable type and size.

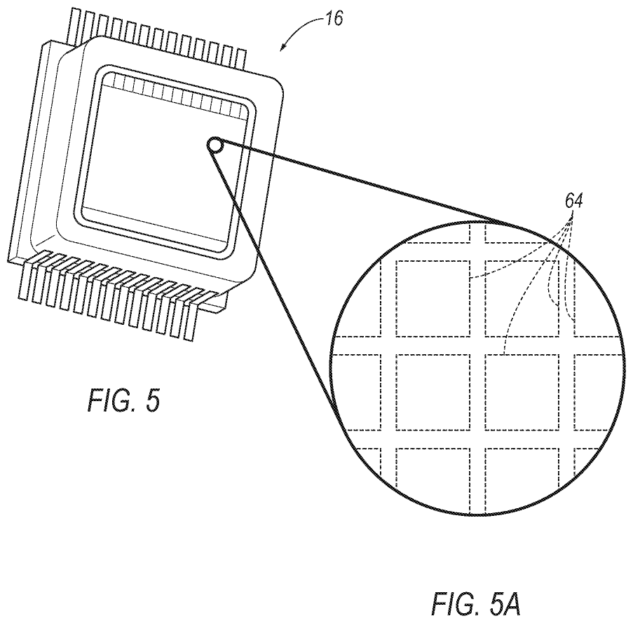

The light detector 16 includes a chip and the array of photodetectors 64 is on the chip. The chip may be silicon (Si), indium gallium arsenide (InGaAs), germanium (Ge), etc., as is known. The chip and the photodetectors 64 are shown schematically in FIGS. 5 and 5A. The array of photodetectors 64 is 2-dimensional. Specifically, the array of photodetectors 64 includes a plurality of photodetectors 64 arranged in a columns and rows (schematically shown in FIGS. 5 and 5A).

Each photodetector 64 is light sensitive. Specifically, each photodetector 64 detects photons by photo-excitation of electric carriers. An output signal from the photodetector 64 indicates detection of light and may be proportional to the amount of detected light. The output signals of each photodetector 64 are collected to generate a scene detected by the photodetector 64.

The photodetector 64 may be of any suitable type, e.g., photodiodes (i.e., a semiconductor device having a p-n junction or a p-i-n junction) including avalanche photodiodes (APD), a single-photon avalanche diode (SPAD), a PIN diode, metal-semiconductor-metal photodetectors 64, phototransistors, photoconductive detectors, phototubes, photomultipliers, etc. The photodetectors 64 may each be of the same type.

Avalanche photo diodes (APD) are analog devices that output an analog signal, e.g., a current that is proportional to the light intensity incident on the detector. APDs have high dynamic range as a result but need to be backed by several additional analog circuits, such as a transconductance or transimpedance amplifier, a variable gain or differential amplifier, a high-speed A/D converter, one or more digital signal processors (DSPs) and the like.

In examples in which the photodetectors 64 are SPADs, the SPAD is a semiconductor device, specifically, an APD, having a p-n junction that is reverse biased (herein referred to as “bias”) at a voltage that exceeds the breakdown voltage of the p-n junction, i.e., in Geiger mode. The bias voltage is at a magnitude such that a single photon injected into the depletion layer triggers a self-sustaining avalanche, which produces a readily-detectable avalanche current. The leading edge of the avalanche current indicates the arrival time of the detected photon. In other words, the SPAD is a triggering device of which usually the leading edge determines the trigger.

The SPAD operates in Geiger mode. “Geiger mode” means that the APD is operated above the breakdown voltage of the semiconductor and a single electron—hole pair (generated by absorption of one photon) can trigger a strong avalanche. The SPAD is biased above its zero-frequency breakdown voltage to produce an average internal gain on the order of one million. Under such conditions, a readily-detectable avalanche current can be produced in response to a single input photon, thereby allowing the SPAD to be utilized to detect individual photons. “Avalanche breakdown” is a phenomenon that can occur in both insulating and semiconducting materials. It is a form of electric current multiplication that can allow very large currents within materials which are otherwise good insulators. It is a type of electron avalanche. In the present context, “gain” is a measure of an ability of a two-port circuit, e.g., the SPAD, to increase power or amplitude of a signal from the input to the output port.

When the SPAD is triggered in a Geiger-mode in response to a single input photon, the avalanche current continues as long as the bias voltage remains above the breakdown voltage of the SPAD. Thus, in order to detect the next photon, the avalanche current must be “quenched” and the SPAD must be reset. Quenching the avalanche current and resetting the SPAD involves a two-step process: (i) the bias voltage is reduced below the SPAD breakdown voltage to quench the avalanche current as rapidly as possible, and (ii) the SPAD bias is then raised by a power-supply circuit 66 to a voltage above the SPAD breakdown voltage so that the next photon can be detected.

Each photodetector 64 can output a count of incident photons, a time between incident photons, a time of incident photons (e.g., relative to an illumination output time), or other relevant data, and the LiDAR sensor 10 can transform these data into distances from the LiDAR sensor 10 to external surfaces in the field of view FOVs. By merging these distances with the position of photodetectors 64 at which these data originated and relative positions of these photodetectors 64 at a time that these data were collected, the LiDAR sensor 10 (or other device accessing these data) can reconstruct a three-dimensional (virtual or mathematical) model of a space occupied by the LiDAR sensor 10, such as in the form of 3D image represented by a rectangular matrix of range values, wherein each range value in the matrix corresponds to a polar coordinate in 3D space. Each photodetector 64 can be configured to detect a single photon per sampling period, e.g., in the example in which the photodetector 64 is a SPAD. The photodetector 64 functions to output a single signal or stream of signals corresponding to a count of photons incident on the photodetector 64 within one or more sampling periods. Each sampling period may be picoseconds, nanoseconds, microseconds, or milliseconds in duration. The photodetector 64 can output a count of incident photons, a time between incident photons, a time of incident photons (e.g., relative to an illumination output time), or other relevant data, and the LiDAR sensor 10 can transform these data into distances from the LiDAR sensor 10 to external surfaces in the fields of view of these photodetectors 64. By merging these distances with the position of photodetectors 64 at which these data originated and relative positions of these photodetectors 64 at a time that these data were collected, the controller 30 (or other device accessing these data) can reconstruct a three-dimensional 3D (virtual or mathematical) model of a space within FOV, such as in the form of 3D image represented by a rectangular matrix of range values, wherein each range value in the matrix corresponds to a polar coordinate in 3D space.

With reference to FIGS. 5 and 5A, the photodetectors 64 may be arranged as an array, e.g., a 2-dimensional arrangement. A 2D array of photodetectors 64 includes a plurality of photodetectors 64 arranged in columns and rows. Specifically, the light detector 16 may be a focal-plane array (FPA).

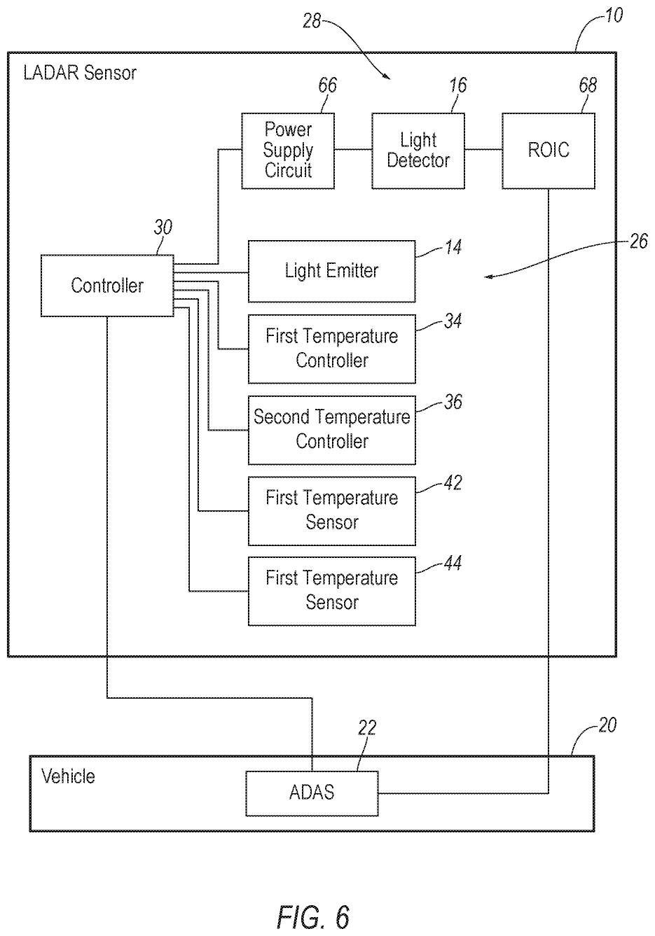

The light detector 16 includes a plurality of pixels. Each pixel may include one or more photodetectors 64. As shown schematically in FIG. 6, the light detector 16, e.g., each of the pixels, include a power-supply circuit 66 and a read-out integrated circuit (ROIC 68). The photodetectors 64 are connected to the power-supply circuit 66 and the ROIC 68. Multiple pixels may share a common power-supply circuit 66 and/or ROIC 68.

The light detector 16 detects photons by photo-excitation of electric carriers. An output from the light detector 16 indicates a detection of light and may be proportional to the amount of detected light, in the case of a PIN diode or APD, and may be a digital signal in case of a SPAD. The outputs of light detector 16 are collected to generate a 3D environmental map, e.g., 3D location coordinates of objects and surfaces within the field of view FOV of the LiDAR sensor 10.

With reference to FIG. 6, the ROIC 68 converts an electrical signal received from photodetectors 64 of the FPA to digital signals. The ROIC 68 may include electrical components which can convert electrical voltage to digital data. The ROIC 68 may be connected to the controller 30, which receives the data from the ROIC 68 and may generate 3D environmental map based on the data received from the ROIC 68.

The power-supply circuits 66 supply power to the photodetectors 64. The power-supply circuit 66 may include active electrical components such as MOSFET (Metal-Oxide-Semiconductor Field-Effect Transistor), BiCMOS (Bipolar CMOS), etc., and passive components such as resistors, capacitors, etc. As an example, the power-supply circuit 66 may supply power to the photodetectors 64 in a first voltage range that is higher than a second operating voltage of the ROIC 68. The power-supply circuit 66 may receive timing information from the ROIC 68.

The light detector 16 may include one or more circuits that generates a reference clock signal for operating the photodetectors 64. Additionally, the circuit may include logic circuits for actuating the photodetectors 64, power-supply circuit 66, ROIC 68, etc.

As set forth above, the light detector 16 includes a power-supply circuit 66 that powers the pixels. The light detector 16 may include a single power-supply circuit 66 in communication with all pixels or may include a plurality of power-supply circuits 66 in communication with a group of the pixels.

The power-supply circuit 66 may include active electrical components such as MOSFET (Metal-Oxide-Semiconductor Field-Effect Transistor), BiCMOS (Bipolar CMOS), IGBT (Insulated-gate bipolar transistor), VMOS (vertical MOSFET), HexFET, DMOS (double-diffused MOSFET) LDMOS (lateral DMOS), BJT (Bipolar junction transistor), etc., and passive components such as resistors, capacitors, etc. The power-supply circuit 66 may include a power-supply control circuit. The power-supply control circuit may include electrical components such as a transistor, logical components, etc. The power-supply control circuit may control the power-supply circuit 66, e.g., in response to a command from the controller 30, to apply bias voltage and quench and reset the SPAD.

In examples in which the photodetector 64 is an avalanche-type photodiode, e.g., a SPAD, to control the power-supply circuit 66 to apply bias voltage, quench, and reset the avalanche-type diodes, the power-supply circuit 66 may include a power-supply control circuit. The power-supply control circuit may include electrical components such as a transistor, logical components, etc. A bias voltage, produced by the power-supply circuit 66, is applied to the cathode of the avalanche-type diode. An output of the avalanche-type diode, e.g., a voltage at a node, is measured by the ROIC 68 circuit to determine whether a photon is detected. The power-supply circuit 66 supplies the bias voltage to the avalanche-type diode based on inputs received from a driver circuit of the ROIC 68. The ROIC 68 may include the driver circuit to actuate the power-supply circuit 66, an analog-to-digital (ADC) or time-to-digital (TDC) circuit to measure an output of the avalanche-type diode at the node, and/or other electrical components such as volatile memory (register), and logical control circuits, etc. The driver circuit may be controlled based on an input received from the circuit of the light detector 16, e.g., a reference clock. Data read by the ROIC 68 may be then stored in, for example, a memory chip. A controller 30, e.g., the controller 30, a controller 30 of the LiDAR sensor 10, etc., may receive the data from the memory chip and generate 3D environmental map, location coordinates of an object within the field of view FOV of the LiDAR sensor 10, etc.

The controller 30 actuates the power-supply circuit 66 to apply a bias voltage to the plurality of avalanche-type diodes. For example, the controller 30 may be programmed to actuate the ROIC 68 to send commands via the ROIC 68 driver to the power-supply circuit 66 to apply a bias voltage to individually powered avalanche-type diodes. Specifically, the controller 30 supplies bias voltage to avalanche-type diodes of the plurality of pixels of the focal-plane array through a plurality of the power-supply circuits 66, each power-supply circuit 66 dedicated to one of the pixels, as described above. The individual addressing of power to each pixel can also be used to compensate manufacturing variations via look-up-table programmed at an end-of-line testing station. The look-up-table may also be updated through periodic maintenance of the LiDAR sensor 10.

The light-receiving system 28 includes a bandpass filter 18 between the light detector 16 and the field of illumination FOI of the light emitter 14. Specifically, the bandpass filter 18 may be between the light detector 16 and the window 32. The bandpass filter 18 is designed to transmit light in a wavelength range (i.e., a bandwidth) including the wavelength of light emitted by the light emitter 14. In other words, the bandpass filter 18 attenuates light having a wavelength outside of the wavelength range from entering the casing through the bandpass filter 18. The bandpass filter 18 may be adjacent the window 32 (e.g., at or on the light detector 16), adjacent the light detector 16 (e.g., at or on the light detector 16), or at any suitable location between the window 32 and the light detector 16 to pass light in the wavelength range to the light detector 16 and attenuate light outside of the wavelength range.

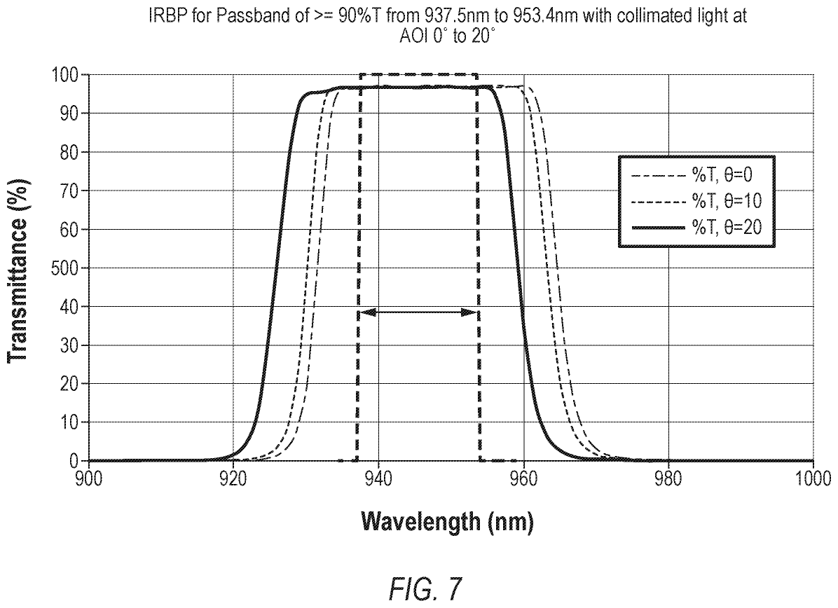

The bandpass filter 18 is designed to pass light to the light detector 16 in a wavelength range that is dependent on the temperature of the bandpass filter 18. In other words, the wavelength range of light passed by the bandpass filter 18 varies with temperature, as shown in the example data of FIG. 7. For example, at a nominal operating temperature, the wavelength range may shift 4 nm lower due to a temperature decrease of 10 C and may shift 4 nm higher due to a temperature increase of 10 C. The nominal operating temperature may be, as an example, 50 C. The temperature-dependent shift in wavelength range is an artifact of material characteristics. In other words, the materials of the bandpass filter 18 change operation based on temperature of the material.

The wavelength range of the bandpass filter 18 at the nominal operating temperature may vary based on manufacturing tolerances. As set forth above, the wavelength of light emitted from the light emitter 14 is also dependent on the temperature of the light emitter 14. Due to the temperature-dependent shift in wavelength range of the bandpass filter 18, the variation based on manufacturing tolerances of the bandpass filter 18, and the temperature-dependent wavelength of light emitted from the light emitter 14, the bandpass filter 18 is designed to have a wavelength range that is of sufficient width to pass light emitted from the light emitter 14 at a range of operating temperatures for both the bandpass filter 18 and the light emitter 14 and also adjusted for potential manufacturing tolerances of the bandpass filter 18. As set forth below, controlling the temperature of the bandpass filter 18 reduces or eliminates the temperature-dependent shift in wavelength range of the bandpass filter 18 and controlling the temperature of the light emitter 14 reduces or eliminates the temperature-dependent changes in wavelength of light emitted from the light emitter 14. Accordingly, the controlling the temperature of the bandpass filter 18 and the light emitter 14 allows for a reduction in the designed width of the wavelength range of the bandpass filter 18 can be minimized to reduce the likelihood of detection of unwanted light by the light detector 16.

As set forth above, the LiDAR sensor 10 includes at least one temperature controller 34, 36, 50. The light emitter 14 is coupled to at least one temperature controller 34, 36, 50 and the bandpass filter 18 is coupled to at least one temperature controller 34, 36, 50. In other words, the light emitter 14 and the bandpass filter 18 are coupled to the same temperature controller 50 or different temperature controllers 34, 36. For example, in the example shown in FIG. 3, one temperature controller, specifically the first temperature controller 34, is coupled to the light emitter 14 and another temperature controller, specifically the second temperature controller 36, is coupled to the bandpass filter 18. As another example, in the example shown in FIG. 4, one temperature controller 50 is coupled to both the light emitter 14 and the bandpass filter 18, i.e., the light emitter 14 and the bandpass filter 18 are coupled to the same temperature controller 50.

As set forth above, the light emitter 14 is coupled to at least one temperature controller 34, 36, 50 and the bandpass filter 18 is coupled to at least one temperature controller 34, 36, 50. In other words, the light emitter 14 is thermally coupled to at least one temperature controller 34, 36, 50 such that the temperature controller 34, 36, 50 controls the temperature of the light emitter 14 and the bandpass filter 18 is thermally coupled to at least one temperature controller 34, 36, 50 such that the temperature controller 34, 36, 50 controls the temperature of the bandpass filter 18. Specifically, the light emitter 14 is arranged such that the respective temperature controller 34, 36, 50 controls the temperature of the light emitter 14 and the bandpass filter 18 is arranged such that the respective temperature controller 34, 36, 50 controls the temperature of the bandpass filter 18. As an example, the light emitter 14 may abut the respective temperature controller 34, 36, 50 and the bandpass filter 18 may abut the respective temperature controller 34, 36, 50. As another example, the light emitter 14 may be in suitable proximity to the respective temperature controller 34, 36, 50 and the bandpass filter 18 may be in suitable proximity to the respective temperature controller 34, 36, 50 to be heated and/or cooled by the respective temperature controller. The respective temperature controller 34, 36, 50 may heat and/or cool the light emitter 14 and the bandpass filter 18 by radiation, conduction, or convection.

As set forth above, the example in FIG. 3 includes the first temperature controller 34 and the second temperature controller 36. The example shown in FIG. 3 including the first temperature controller 34 and the second temperature controller 36 is also shown in the block diagram of FIG. 6. In the example in FIGS. 3 and 6, the first temperature controller 34 and the second temperature controller 36 control the temperature independently control the temperature of the light emitter 14 and the bandpass filter 18. The first temperature controller 34 heats and/or cools the light emitter 14 without heating and/or cooling the bandpass filter 18 and the second temperature controller 36 heats and/or cools the bandpass filter 18 without heating and/or cooling the light emitter 14. This allows for the temperature of the light emitter 14 to be adjusted and the temperature of the bandpass filter 18 to be adjusted independently of each other. Typically, the first temperature controller 34 cools the temperature of the light emitter 14. The second temperature controller 36 may cool and/or heat the bandpass filter 18.

With continued reference to FIGS. 3 and 6, as an example, the first temperature controller 34 may be a first thermo-electric temperature controller coupled to the light emitter 14 and/or the second temperature controller 36 may be a second thermo-electric temperature controller coupled to the bandpass filter 18. In such examples, the thermo-electric temperature controller, as is known, uses the Peltier effect to create a heat flux between two different types of materials, e.g., with semiconductor junctions between two ceramic plates. The thermo-electric temperature controller may selectively heat and cool. In other words, the thermo-electric temperature controller generates heating when operated in one direction and generates cooling when operated in the opposite direction. The thermo-electric temperature controller may be of a known type. In the example of FIGS. 3 and 6, the thermo-electric temperature controllers are controlled by the controller to independently heat and/or cool the light emitter 14 and the bandpass filter 18. In the example in FIGS. 3 and 6, the first thermo-electric temperature controller may abut the light emitter 14 and the second thermo-electric temperature controller may abut the bandpass filter 18. As an example, the first thermo-electric temperature controller may abut the light emitter 14 on a side of the light emitter 14 opposite from the light emission, i.e., a base of the light emitter 14 may be on the first thermo-electric temperature controller. The second thermo-electric temperature controller may abut the bandpass filter 18, for example, in a frame surrounding a window of the bandpass filter 18 through which the field of view of the light detector 16 extends.

With reference to FIG. 4, the LiDAR sensor 10 may include one temperature controller 50 that simultaneously controls the temperature of the light emitter 14 and the temperature of the bandpass filter 18. In such an example, the temperature controller 50 may transfer heat between the light emitter 14 and the bandpass filter 18 to seek to maintain the light emitter 14 and the bandpass filter 18 at a common temperature. As an example, the temperature controller 50 may transfer heat from the light emitter 14 to the bandpass filter 18 to reduce the temperature of the light emitter 14 and increase the temperature of the bandpass filter 18. This heat transfer attempts to reduce the temperature of the light emitter 14 and increase the temperature of the bandpass filter 18 to a common temperature.

With continued reference to FIG. 4, the temperature controller may be a heat pipe 50 coupled to both the light emitter 14 and the bandpass filter 18. The heat pipe 50, as is known, includes a sealed pipe and a working fluid sealed in the pipe. Specifically, the sealed pipe is sealed at a vacuum so that the working fluid changes between liquid and vapor during anticipated operating temperature of the heat pipe 50. In operation, when one end of the heat pipe 50 is heated, e.g., from the light emitter 14, the fluid at that end changes from liquid to vapor. The vapor travels to the other end of the heat pipe 50 and condenses to liquid to release heat at the other end, e.g., at the bandpass filter 18.

As set forth above, the heat pipe 50 is coupled to both the light emitter 14 and the bandpass filter 18. Specifically, the light emitter 14 is arranged such that the heat pipe 50 is heated by the light emitter 14 and the to cool the light emitter 14 and the bandpass filter 18 is arranged such that the heat pipe 50 heats the bandpass filter 18. As an example, the heat pipe 50 may abut the light emitter 14 and the bandpass filter 18. For example, the light emitter 14 may include a cover glass 46 and the heat pipe 50 may abut the cover glass 46. The heat pipe 50 may abut the bandpass filter 18, for example, in a frame surrounding a window of the bandpass filter 18 through which the field of view FOV of the light detector 16 extends.

In the examples of FIGS. 3 and 4, control of the temperature of the light emitter 14 and the bandpass filter 18 reduces the required wavelength range of the bandpass filter 18 to reduce the possibility of detection of unwanted light by the light detector 16. As an example, the wavelength range of the bandpass filter 18 may be less than 15 nm, as shown in the dotted line in the middle of FIG. 7. More specifically, the wavelength range of the bandpass filter 18 may be less than 10 nm, and more specifically, may be less than 6 nm. Further, in the example shown in FIG. 3, the independent control of the temperature of the light emitter 14 and the bandpass filter 18 improves the compatibility of a wider range of light emitter 14s and bandpass filter 18s. In other words, the operating specifications of the light emitter 14 and the bandpass filter 18 have decreased importance because the light emitter 14 and/or the bandpass filter 18 may be operated at any suitable temperature to align the wavelength of the light emitted by the light emitter 14 with the wavelength range of the bandpass filter 18.

In the example in FIGS. 3 and 6, the LiDAR sensor 10 may sense the temperature of the light emitter 14 and the bandpass filter 18 to control the temperature. In other words, the LiDAR sensor 10 uses temperature measurements as feedback to adjust the first temperature controller 34 and the second temperature controller 36 to achieve the desired temperature of the light emitter 14 and the bandpass filter 18. For example, with reference to FIGS. 3 and 6, the LiDAR sensor 10 includes a first temperature sensor 42 coupled to the light emitter 14 and a second temperature sensor 44 coupled to the bandpass filter 18. Specifically, the first temperature sensor 42 is arranged such that the first temperature sensor 42 detects the temperature of the light emitter 14 and the second temperature sensor 44 is arranged such that the second temperature sensor 44 detects the temperature of the bandpass filter 18. For example, the first temperature sensor 42 may abut the light emitter 14 and the second temperature sensor 44 may abut the bandpass filter 18. The first temperature sensor 42 may be, for example, a first thermocouple coupled to the light emitter 14 to detect the temperature of the light emitter 14 and the second temperature sensor 44 may be, for example, a second thermocouple coupled to the bandpass filter 18 to detect the temperature of the bandpass filter 18.

The LiDAR sensor 10 may include a means for controlling the temperature of the light emitter 14 and the bandpass filter 18. As an example, the means may include the first temperature controller 34 and the second temperature controller 36 (e.g., the first thermo-electric temperature controller and the second thermo-electric temperature controller), the heat pipe 50, and equivalents thereof. In some examples, the means may include the first temperature sensor 42 and the second temperature sensor 44, e.g., the first thermocouple and the second thermocouple. The means controls the temperature of the light emitter 14 and the bandpass filter 18. For example, the means independently controls the temperature of the light emitter 14 and the bandpass filter 18, e.g., as described above with respect to the first temperature controller 34 and the second temperature controller 36. As another example, the means simultaneously controls the temperature of the light emitter 14 and the bandpass filter 18, e.g., as described above with respect to the heat pipe 50.

The controller 30 is in electronic communication with the pixels (e.g., with the ROIC 68 and power-supply circuit 66) and the vehicle 20 (e.g., with the ADAS 22) to receive data and transmit commands. The controller 30 may be configured to execute operations disclosed herein.

The controller 30 is a physical, i.e., structural, component of the LiDAR sensor 10. The controller 30 may be a microprocessor-based controller 30, an application specific integrated circuit (ASIC), field programmable gate array (FPGA), etc., or a combination thereof, implemented via circuits, chips, and/or other electronic components.

For example, the controller 30 may include a processor, memory, etc. In such an example, the memory of the controller 30 may store instructions executable by the processor, i.e., processor-executable instructions, and/or may store data. The memory includes one or more forms of controller 30—readable media, and stores instructions executable by the controller 30 for performing various operations, including as disclosed herein. As another example, the controller 30 may be or may include a dedicated electronic circuit including an ASIC (application specific integrated circuit) that is manufactured for a particular operation, e.g., calculating a histogram of data received from the LiDAR sensor 10 and/or generating a 3D environmental map for a field of view FOV of the light detector 16 and/or an image of the field of view FOV of the light detector 16. As another example, the controller 30 may include an FPGA (field programmable gate array) which is an integrated circuit manufactured to be configurable by a customer. As an example, a hardware description language such as VHDL (very high speed integrated circuit hardware description language) is used in electronic design automation to describe digital and mixed-signal systems such as FPGA and ASIC. For example, an ASIC is manufactured based on hardware description language (e.g., VHDL programming) provided pre-manufacturing, and logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging. A controller may be a set of controllers communicating with one another via a communication network of the vehicle, e.g., a controller in the LiDAR sensor 10 and a second controller in another location in the vehicle.

The controller 30 may be in communication with the communication network of the vehicle to send and/or receive instructions from the vehicle 20, e.g., components of the ADAS 22. The controller 30 is programmed to perform the method 800 and function described herein and shown in the figures. For example, in an example including a processor and a memory, the instructions stored on the memory of the controller 30 include instructions to perform the method 800 and function described herein and shown in the figures; in an example including an ASIC, the hardware description language (e.g., VHDL) and/or memory electrically connected to the circuit include instructions to perform the method 800 and function described herein and shown in the figures; and in an example including an FPGA, the hardware description language (e.g., VHDL) and/or memory electrically connected to the circuit include instructions to perform the method 800 and function described herein and shown in the figures. Use herein of “based on,” “in response to,” and “upon determining,” indicates a causal relationship, not merely a temporal relationship.

The controller 30 may provide data, e.g., a 3D environmental map and/or images, to the ADAS 22 of the vehicle 20 and the ADAS 22 may operate the vehicle 20 in an autonomous or semi-autonomous mode based on the data from the controller 30. For purposes of this disclosure, an autonomous mode is defined as one in which each of vehicle propulsion, braking, and steering are controlled by the controller 30 and in a semi-autonomous mode the controller 30 controls one or two of vehicle propulsion, braking, and steering. In a non-autonomous mode a human operator controls each of vehicle propulsion, braking, and steering.

The controller 30 may include or be communicatively coupled to (e.g., through the communication network) more than one processor, e.g., controllers or the like included in the vehicle 20 for monitoring and/or controlling various vehicle controllers, e.g., a powertrain controller, a brake controller, a steering controller, etc. The controller 30 is generally arranged for communications on a vehicle communication network that can include a bus in the vehicle such as a controller area network (CAN) or the like, and/or other wired and/or wireless mechanisms.

With reference to the example shown in FIGS. 3 and 6, the controller is programmed to independently control the first temperature controller 34, e.g., the first thermo-electric temperature controller, and the second temperature controller 36, e.g., the second thermo-electric temperature controller. In other words, the controller controls the first temperature controller 34 to control the temperature of the light emitter 14 without controlling the temperature of the bandpass filter 18 and the controller controls the second temperature controller 36 to control the temperature of the bandpass filter 18 without controlling the temperature of the light emitter 14. Specifically, the controller may operate the first temperature controller 34 while the second temperature controller 36 is not operated, may operate the second temperature controller 36 while the first temperature controller 34 is not operated, and may simultaneously operate the first temperature controller 34 and the second temperature controller 36 and in each of those examples the level of heating/cooling may be different for the first temperature controller 34 and the second temperature controller 36 to achieve the desired temperatures of the light emitter 14 and the bandpass filter 18.

With continued reference to the example shown in FIGS. 3 and 6, the controller 30 is programmed to adjust the temperature of the light emitter 14 toward a desired operating temperature (e.g., 70 C) of the light emitter 14 and the controller 30 is programmed to adjust the temperature of the bandpass filter 18 toward a desired operating temperature (e.g., 50 C) of the bandpass filter 18. The desired operating temperatures of the light emitter 14 and the bandpass filter 18 may be different values. The desired operating temperatures of the light emitter 14 and the bandpass filter 18 may be, for example, determined by empirical data, manufacturer's operating specification, etc.

The controller 30 may be programmed to adjust the temperature of the light emitter 14 and the bandpass filter 18 based on temperature measurements of the light emitter 14 and the bandpass filter 18. Specifically, the controller 30 is programmed to control the first temperature controller 34, e.g., the first thermo-electric temperature controller 30, based on measured temperature of the light emitter 14 and the controller 30 may be programmed to control the second temperature controller 36, e.g., the second thermo-electric temperature controller 30, based on measured temperature of the bandpass filter 18. Specifically, based on the temperature measurements of the light emitter 14 and the bandpass filter 18 the controller 30 may be programmed to adjust the temperature of the light emitter 14 toward the desired operating temperature of the light emitter 14 and to adjust the temperature of the bandpass filter 18 toward the desired operating temperature of the bandpass filter 18. The adjustment to the temperature of the light emitter 14 and the bandpass filter 18 may be an adjustment toward the. As one example, the adjustment of the temperature of the light emitter 14 may be continuous and changed with every temperature measurement of the light emitter 14 unless the temperature of the light emitter 14 is at the desired operating temperature of the light emitter 14. Likewise, the adjustment of the temperature of the bandpass filter 18 may be continuous and changed with every temperature measurement of the bandpass filter 18 unless the temperature of the bandpass filter 18 is at the desired operating temperature of the bandpass filter 18. As another example, the adjustment of the temperature of the light emitter 14 may be made in response to detection of a difference between the temperature of the light emitter 14 and the desired operating temperature of the light emitter 14 that exceeds a predetermined value or percentage and the adjustment of the temperature of the bandpass filter 18 may be made in response to detection of a difference between the temperature of the bandpass filter 18 and the desired operating temperature of the bandpass filter 18 that exceeds a predetermined value or percentage.

The controller 30 adjusts the temperature of the light emitter 14 and the bandpass filter 18 by controlling inputs to the first temperature controller 34 and the second temperature controller 36. For example, the controller 30 may change the amount and/or direction of current applied to the first temperature controller 34, e.g., the first thermo-electric temperature controller 30, and the second temperature controller 36, e.g., the second thermo-electric temperature controller 30.

The controller 30 may be programmed to receive a temperature measurement of the light emitter 14 and a temperature measurement of the bandpass filter 18. The controller 30 is programmed to control the temperature of the light emitter 14 based on the measured temperature of the light emitter 14 and to control the temperature of the light bandpass filter 18 based on the measured temperature of the bandpass filter 18, as described above. As an example, the controller 30 may be programmed to receive measurements from the first temperature sensor 42 and the second temperature sensor 44, e.g., the first thermocouple and the second thermocouple.

The controller 30 is programmed to monitor the temperature of the light emitter 14 with repeated temperature measurements of the light emitter 14 and to monitor the temperature of the bandpass filter 18 with repeated temperature measurements of the bandpass filter 18. As set forth above, the controller 30 is programmed to adjust the temperature of the light emitter 14 in response to the repeated temperature measurements of the light emitter 14 and to adjust the temperature of the bandpass filter 18 in response to the repeated temperature measurements of the bandpass filter 18. As an example, the controller 30 may periodically repeat temperature measurements based on time, number of firings of the light emitter 14, etc.

As set forth above, the controller 30 is programmed to perform the method 800 shown in FIG. 8. With reference to FIG. 8, the method includes maintaining the temperatures of the light emitter 14 and the bandpass filter 18 at their respective desired operating temperatures and operating the LiDAR sensor 10 while the light emitter 14 and the bandpass filter 18 are at the desired operating temperatures. Specifically, the method includes controlling the temperature of the bandpass filter 18 to pass light in a wavelength range; and controlling the temperature of the light emitter 14 to emit light having a wavelength in the wavelength range of the bandpass filter 18. As shown with the loopback arrow from block 825 to block 805, the method 800 is repeated to continuously monitor and adjust the temperatures of the light emitter 14 and the bandpass filter 18. As set forth above, the method 800 may be repeated periodically based on time, number of firings of the light emitter 14, etc.

With reference to block 805, the method 800 includes receiving temperature measurements of the light emitter 14 and, with reference to block 810, the method 800 includes receiving temperature measurements of the bandpass filter 18. In blocks 805 and 810, receiving temperature measurements includes receiving temperature measurements from the first temperature sensor 42 and the second temperature sensor 44, e.g., the first thermocouple and the second thermocouple. Blocks 805 and 810 are repeated, as shown in the loopback arrow from block 825. Blocks 805 and 810 may be performed in any order or simultaneously. Block 805 and block 810 may be performed for each iteration of method 800 or one of block 805 or 810 may be skipped to proceed to block 805 in some iterations of the method 800.

In blocks 815-825, the method includes receiving a temperature measurement of the light emitter 14 and controlling the temperature of the light emitter 14 based on the measured temperature of the light emitter 14; and receiving a temperature measurement of the bandpass filter 18 and controlling the temperature of the light bandpass filter 18 based on the measured temperature of the bandpass filter 18.

With reference to block 815, the method 800 includes determining whether the light emitter 14 and the bandpass filter 18 are at predetermined temperatures, e.g., the desired operating temperature. In block 815, the method 800 may include comparing the temperature measurements of the light emitter 14 and the bandpass filter 18 to the desired operating temperature of the light emitter 14 and the bandpass filter 18, respectively.

In block 820, the method 800 includes adjusting the temperature of the light emitter 14 and/or the bandpass filter 18 in response to determination in block 815 that the temperature of the light emitter 14 and/or the temperature of the bandpass filter 18 is not at the respective desired operating temperature. Specifically, the method 800 in block 820 includes adjusting the first temperature controller 34 (e.g., the first thermo-electric temperature controller 30) and the second temperature controller 36 (e.g., the second thermo-electric temperature controller 30), as described above. The adjustment of the temperature may be periodic, e.g., in response to periodic temperature measurements, as described above, that detect temperatures outside of the desired operating temperatures.

In block 825, the method 800 includes operating the light emitter 14 and the light detector 16, as described above. Specifically, block 825 includes emitting light from the light emitter 14 into the field of illumination FOI and, with the light detector 16, detecting reflected light in the field of view of the light detector 16 through the bandpass filter 18, as described above. Since the temperatures of the light emitter 14 and the bandpass filter 18 are controlled, the light emitted from the light emitter 14 is at a wavelength within the wavelength range of the bandpass filter 18.

As set forth above, as shown with the loopback arrow from block 825 to block 805, the method 800 includes monitoring the temperature of the light emitter 14 with repeated temperature measurements of the light emitter 14 and adjusting the temperature of the light emitter 14 in response to the repeated temperature measurements of the light emitter 14 and the method 800 includes monitoring the temperature of the bandpass filter 18 with repeated temperature measurements of the bandpass filter 18 and adjusting the temperature of the bandpass filter 18 in response to the repeated temperature measurements of the bandpass filter 18.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A LiDAR sensor comprising:
a light emitter designed to emit light into a field of illumination, the wavelength of the light emitted by the light emitter being dependent on the temperature of the light emitter;
a light detector having a field of view overlapping the field of illumination;
a bandpass filter between the light detector and the field of illumination of the light emitter, the bandpass filter being designed to pass light to the light detector in a wavelength range that is dependent on the temperature of the bandpass filter; and
at least one temperature controller, the light emitter being coupled to at least one of the at least one temperature controller and the bandpass filter being coupled to at least one of the at least one temperature controller.

2. The LiDAR sensor as set forth in claim 1, wherein the at least one temperature controller is further defined as a first temperature controller coupled to the light emitter to control the temperature of the light emitter and a second temperature controller coupled to the bandpass filter to control the temperature of the bandpass filter independently of the first temperature controller.

3. The LiDAR sensor as set forth in claim 2, further comprising a first temperature sensor coupled to the light emitter and a second temperature sensor coupled to the bandpass filter.

4. The LiDAR sensor as set forth in claim 2, further comprising a first thermocouple coupled to the light emitter to detect the temperature of the light emitter and a second thermocouple coupled to the bandpass filter to detect the temperature of the bandpass filter.

5. The LiDAR sensor as set forth in claim 1, wherein:
the at least one temperature controller is further defined as a first temperature controller coupled to the light emitter and a second temperature controller coupled to the bandpass filter; and
a controller programmed to independently control the first temperature controller and the second temperature controller.

6. The LiDAR sensor as set forth in claim 5, wherein the controller is programmed to:
control the first temperature controller based on measured temperature of the light emitter; and
control the second temperature controller based on measured temperature of the bandpass filter.

7. The LiDAR sensor as set forth in claim 6, further comprising a first temperature sensor coupled to the light emitter and a second temperature sensor coupled to the bandpass filter.

8. The LiDAR sensor as set forth in claim 5, wherein the controller is programmed to:
receive a temperature measurement of the light emitter and control the temperature of the light emitter based on the measured temperature of the light emitter; and
receive a temperature measurement of the bandpass filter and control the temperature of the light bandpass filter based on the measured temperature of the bandpass filter.

9. The LiDAR sensor as set forth in claim 5, wherein the controller is programmed to:
monitor the temperature of the light emitter with repeated temperature measurements of the light emitter and adjust the temperature of the light emitter in response to the repeated temperature measurements of the light emitter; and
monitor the temperature of the bandpass filter with repeated temperature measurements of the bandpass filter and adjust the temperature of the bandpass filter in response to the repeated temperature measurements of the bandpass filter.

10. The LiDAR sensor as set forth in claim 1, wherein the at least one temperature controller is further defined as a first thermo-electric temperature controller coupled to the light emitter and a second thermo-electric temperature controller coupled to the bandpass filter.

11. The LiDAR sensor as set forth in claim 1, wherein the at least one temperature controller is a heat pipe coupled to both the light emitter and the bandpass filter.

12. The LiDAR sensor as set forth in claim 11, wherein the light emitter includes a cover glass and the heat pipe abuts the cover glass and the bandpass filter.

13. The LiDAR sensor as set forth in claim 1, wherein light emitter includes a cover glass and the at least one temperature controller abuts the cover glass.

14. The LiDAR sensor as set forth in claim 1, wherein the at least one temperature controller abuts the bandpass filter.

15. The LiDAR sensor as set forth in claim 1, wherein the wavelength range of the bandpass filter is less than 10 nm.

16. The LiDAR sensor as set forth in claim 1, wherein the at least one temperature controller is further defined as a means for controlling the temperature of the light emitter and the bandpass filter

17. A method of operating a LiDAR sensor, the method comprising:
emitting light from a light emitter into a field of illumination;
with a light detector, detecting light from the field of illumination through a bandpass filter;
controlling the temperature of the bandpass filter to pass light in a wavelength range; and
controlling the temperature of the light emitter to emit light having a wavelength in the wavelength range of the bandpass filter.

18. The method as set forth in claim 16, further comprising:
receiving a temperature measurement of the light emitter and controlling the temperature of the light emitter based on the measured temperature of the light emitter; and
receiving a temperature measurement of the bandpass filter and controlling the temperature of the light bandpass filter based on the measured temperature of the bandpass filter.

19. The method as set forth in claim 16, further comprising:
monitoring the temperature of the light emitter with repeated temperature measurements of the light emitter and adjusting the temperature of the light emitter in response to the repeated temperature measurements of the light emitter; and
monitoring the temperature of the bandpass filter with repeated temperature measurements of the bandpass filter and adjusting the temperature of the bandpass filter in response to the repeated temperature measurements of the bandpass filter.

20. The method as set forth in claim 18, wherein the repeated temperature measurements of the light emitter are periodic and the repeated measurements of the light emitter are periodic.
